(19) United States
(12) Patent Application Publication
(10) Pub. No.: US 2026/0208623 A1
(43) Pub. Date: Jul. 23, 2026

(54) PASSIVE CELL BALANCING

(71) Applicant: GM GLOBAL TECHNOLOGY OPERATIONS LLC, Detroit, MI (US)

(72) Inventors: Justin Anthony Bunnell, Cary, NC (US); Balin Kumar Shrivastava, Waterford, MI (US)

(73) Assignee: GM GLOBAL TECHNOLOGY OPERATIONS LLC, Detroit, MI (US)

(21) Appl. No.: 19/030,468

(22) Filed: Jan. 17, 2025

(51) Int. Cl. B60L 58/22; B60L 50/60; B60L 58/12; H01M 10/44; H01M 10/46; H01M 50/51

(52) U.S. Cl. CPC B60L 58/22; B60L 50/60; B60L 58/12; H01M 10/441; H01M 10/46; H01M 50/51; H01M 2220/20

(57) ABSTRACT

Battery systems and methods for balancing batteries are provided. A battery system includes groups connected in series, wherein each group has a balancing window defined between an upper voltage V₁ and a lower voltage V₂; each group has a minimum idle voltage V₃; V₁>V₂>V₃; each group comprises at least one cell; and each cell independently has a self-discharge current less than or equal to self-discharge current I_{SD}; and a diode arrangement configured to passively reduce a difference in voltage between groups, wherein: the diode arrangement comprises diodes; each diode is connected electrically in parallel with a respective group; each diode is configured to drain the respective group with a same first diode current I_{D1} at voltage V₁, with a same second diode current I_{D2} at voltage V₂, and with same a third diode current I_{D3} at voltage V₃; I_{D1}>I_{D2}>I_{D3}>0; and I_{D1}>I_{D2}+I_{SD}.

### INTRODUCTION

The technical field generally relates to rechargeable energy storage systems (“RESS”) and more particularly relates to cell voltage balancing methods and systems.

Rechargeable energy storage systems, including lithium-ion and related batteries, are increasingly being used in a variety of fields as a way to more efficiently generate, store, and distribute electrical power. In automotive applications, rechargeable energy storage systems are being used as a way to supplement, in the case of hybrid electric vehicles (HEVs), or supplant, in the case of purely electric vehicles (EVs), i.e., battery electric vehicles (BEVs), conventional internal combustion engines. The ability to passively store energy from stationary and portable sources, as well as from recaptured kinetic energy provided by the vehicle and its components, makes batteries ideal to serve as part of a propulsion system for cars, trucks, buses, motorcycles and related vehicular platforms.

Battery cells within a RESS may exhibit different characteristics. For instance, battery cells located in one part of the battery pack may be subject to different temperatures than those located in a different area of the pack. These and other factors may, in turn, affect the individual cell voltage, current, resistance, state-of-charge (SOC), state-of-health (SOH) and/or other battery cell conditions over time, and can lead to discrepancies between the battery cells so that they are not identical. Another potential source of battery cell discrepancy involves limitations in the manufacturing process, as such a process is not always capable of producing battery packs having perfectly identical cells.

It is usually desirable to maintain a battery pack such that the cell voltages are balanced and evenly distributed across the pack; some active cell balancing techniques have been developed for this purpose.

It is desirable to provide methods and systems for passive balancing of cell voltages in a battery system or RESS. Furthermore, other desirable features and characteristics of the present disclosure will become apparent from the subsequent detailed description and the appended claims, taken in conjunction with the accompanying drawings and the foregoing introduction.

### Summary

In one embodiment, a battery system includes battery cell groups connected electrically in series in a battery stack, wherein: each battery cell group has a desired cell balancing window defined between an upper limit voltage V₁ and a lower limit voltage V₂; each battery cell group has a minimum idle voltage V₃; V₁>V₂>V₃; each battery cell group includes at least one battery cell; and each battery cell independently has a self-discharge current less than or equal to a maximum self-discharge current I_{SD}; and a diode arrangement configured to passively reduce a difference in voltage between battery cell groups, wherein: the diode arrangement includes diodes; each diode is connected electrically in parallel with a respective battery cell group; each diode is configured to drain the respective battery cell group with a same first diode current I_{D1} at voltage V₁, with a same second diode current I_{D2} at voltage V₂, and with a same third diode current I_{D3} at voltage V₃; I_{D1}>I_{D2}>I_{D3}>0; and I_{D1}>I_{D2}+I_{SD}.

In certain embodiments, the battery system further includes resistors connected between the battery cell groups and respective diodes.

In certain embodiments, the battery system further includes a controller configured to drive cell group balancing by: determining that the battery cell groups need to be balanced; and charging the battery stack to a specified voltage when the battery cell groups need to be balanced.

In certain embodiments of the battery system, the controller determines that the battery cell groups need to be balanced based on a difference in State of Charge (SOC) and/or a difference in Voltage.

In certain embodiments of the battery system, the specified voltage is selected from a maximum cell voltage rating, a charge complete open circuit voltage, and charge voltage clamp.

In certain embodiments of the battery system, the controller is configured to: determine that the battery cell groups are in balance; and cease charging of the battery stack to allow the battery cell groups to drain when the battery cell groups are in balance.

In certain embodiments of the battery system, the controller is configured to: determine that the battery cell groups are in balance; and cease charging of the battery stack and discharge the battery stack to a target charge level when the battery cell groups are in balance.

In certain embodiments of the battery system, the target charge level is less than the specified voltage.

In certain embodiments of the battery system, the controller is configured to: determine that the battery stack is below a threshold SOC; and charge the battery stack when the battery stack is below the threshold SOC.

In certain embodiments of the battery system, the controller is configured to: identify whether use of the battery system is imminent; and when use of the battery system is imminent, delaying cell group balancing.

In another embodiment, a vehicle includes an electric motor configured to provide motive torque; and a battery system operatively connected to the electric motor and operable to provide electrical power to the electric motor, wherein the battery system includes a high voltage rechargeable battery including battery stacks including battery cell groups, wherein: each battery cell group has a desired cell balancing window defined between an upper limit voltage V₁ and a lower limit voltage V₂; each battery cell group has a minimum idle voltage V₃; V₁>V₂>V₃; and each battery cell group includes at least one battery cell; and each battery cell independently has a self-discharge current less than or equal to a maximum self-discharge current I_{SD}; and a diode arrangement configured to passively reduce a difference in voltage between battery cell groups, wherein: the diode arrangement includes diodes; each diode is connected electrically in parallel with a respective battery cell group; each diode is configured to drain the respective battery cell group with a same first diode current I_{D1} at voltage V₁, with a same second diode current I_{D2} at voltage V₂, and with a same third diode current I_{D3} at voltage V₃; I_{D1}>I_{D2}>I_{D3}>0; and I_{D1}>I_{D2}+I_{SD}.

In certain embodiments of the vehicle, the battery system further includes a controller configured to drive cell group balancing by: determining that battery cell groups in a battery stack need to be balanced; and charging the respective battery stack to a specified voltage when the battery cell groups need to be balanced.

In certain embodiments of the vehicle, the controller is configured to: determine that the battery cell groups in the respective battery stack are in balance; and cease charging of the respective battery stack to allow the battery cell groups to drain when the battery cell groups are in balance.

In certain embodiments of the vehicle, the controller is configured to: determine that the battery cell groups in the respective battery stack are in balance; and cease charging of the respective battery stack and discharge the respective battery stack to a target charge level when the battery cell groups are in balance.

In certain embodiments of the vehicle, the controller is configured to: determine that the respective battery stack is below a threshold SOC; and charge the battery stack when the battery stack is below the threshold SOC.

In another embodiment, a method is provided for cell balancing a battery and includes connecting battery cell groups electrically in series in a battery stack, wherein: each battery cell group has a desired cell balancing window defined between an upper limit voltage V₁ and a lower limit voltage V₂; each battery cell group has a minimum idle voltage V₃; V₁>V₂>V₃; each battery cell group includes at least one battery cell; each battery cell independently has a self-discharge current less than or equal to a maximum self-discharge current I_{SD}; and interconnecting a diode arrangement with the battery cell groups, wherein the diode arrangement is configured to passively reduce a difference in voltage between battery cell groups, wherein: the diode arrangement includes diodes; each diode is connected electrically in parallel with a respective battery cell group; each diode is configured to drain the respective battery cell group with a same first diode current I_{D1} at voltage V₁, with a same second diode current I_{D2} at voltage V₂, and with a same third diode current I_{D3} at voltage V₃; I_{D1}>I_{D2}>I_{D3}>0; and I_{D1}>I_{D2}+I_{SD}.

In certain embodiments, the method further includes driving cell balancing with a controller by: determining, via the controller, that the battery cell groups need to be balanced; and charging the battery stack to a specified voltage when the battery cell groups need to be balanced.

In certain embodiments of the method, the controller determines that the battery cell groups need to be balanced based on a difference in State of Charge (SOC) and/or a difference in Voltage.

In certain embodiments, the method further includes determining, via the controller, that the battery cell groups are in balance; and ceasing charging of the battery stack to allow the battery cell groups to drain when the battery cell groups are in balance.

In certain embodiments, the method further includes determining, via the controller, that the battery cell groups are in balance; and ceasing charging of the battery stack and discharging the battery stack to a target charge level when the battery cell groups are in balance.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes an RESS and a control system for control thereof, among various other components, in accordance with exemplary implementations;

FIG. 2 is a schematic illustrated battery cells in cell groups in a portion of the RESS of FIG. 1, in accordance with exemplary implementations;

FIG. 3 is a graph illustrating the instantaneous forward characteristics of diodes which may be electrically connected to the battery cell groups of FIG. 2, in accordance with exemplary implementations;

FIG. 4 is a flow chart illustrating a method for designing operation of a diode arrangement and battery system, such as shown in FIG. 2, for cell group balancing, in accordance with exemplary implementations; and

FIG. 5 is a flow chart illustrating a method for actively supporting passive cell group balancing, in accordance with exemplary implementations.

### DETAILED DESCRIPTION

The following detailed description is merely exemplary in nature and is not intended to limit the disclosure or the application and uses thereof. Furthermore, there is no intention to be bound by any theory presented in the preceding introduction or summary or the following detailed description.

Embodiments herein provide a vehicle with a battery system with passive cell balancing, a battery system with passive cell balancing, and a method for performing cell balancing. The term “cell balancing” may be used to describe balancing across battery cells groups and may also be referred to as “cell group balancing”. These phrases may be used interchangeably herein. In certain embodiments, each cell group may include a single cell such that cell group balancing occurs at the level of individual cells. In other embodiments, each cell group includes multiple cells such that balancing occurs at the level of cell groups. In the battery system, the arrangement of components provides for automatic cell balancing without any active intervention. Specifically, battery cell groups are electrically connected in parallel to diodes. The diodes continuously discharge the battery cell groups at varying rates. For example, at an upper voltage limit, a diode will discharge a respective battery cell group at a fastest rate. At a lower voltage limit, the diode will discharge the respective battery cell group at a relatively slower rate. Thus, the diode arrangement will automatically reduce a voltage spread between a battery cell group initially at the upper voltage limit and a battery cell group at a voltage lower than the upper voltage limit.

In certain embodiments, a controller is provided to optimize use of the passive cell balancing. Specifically, as provided by the system, cell balancing occurs most quickly when the battery cell groups are at a voltage within a predetermined cell balancing voltage window, i.e., between a highest voltage limit and a lower voltage limit. In certain embodiments, the control system is used to identify when the battery cell groups are at voltages below the predetermined voltage window and then to charge the stack of battery cell groups to the upper limit of the predetermined voltage window. As a result, the behavior of the passive cell balancing diodes are optimized to more quickly balance battery cell groups.

Further, in certain embodiments, the controller is provided to avoid situations in which the battery cell groups are depleted below a minimum operating voltage. Because the diodes continuously discharge the battery cell groups in embodiments herein, the controller may provide for ensuring that the battery cell groups do not reach the minimum operating voltage, and may provide for automatically charging the battery cell groups when they approach the minimum operating voltage.

Further, in certain embodiments, the lower limit of the optimized cell balancing window may be higher than a target charge level. For example, certain battery chemistries degrade or perform poorly in terms of longevity when stored at higher voltages. Thus, such batteries may perform better when stored at a lower voltage level, i.e., the target charge level. Therefore, the controller may be provided to avoid situations in which cell balancing is completed and the battery is slowly drained down from the lower voltage limit by the diodes. Rather, the controller automatically discharges the battery down to the target charge level after cell balancing is completed.

In embodiments herein, cell balancing on-time is a function of cell voltage. This means that controls may be used to force cell voltages to target windows on the diode's I-V curve. It may also result in more frequent “recharge” events due to more parasitic loads from the cell balancing hardware, which is always balancing (diode current as a function of cell voltage).

Embodiments of the present disclosure offer certain advantages, though it is understood that other embodiments may offer different advantages, not all advantages are necessarily discussed herein, and no particular advantage is required for all embodiments.

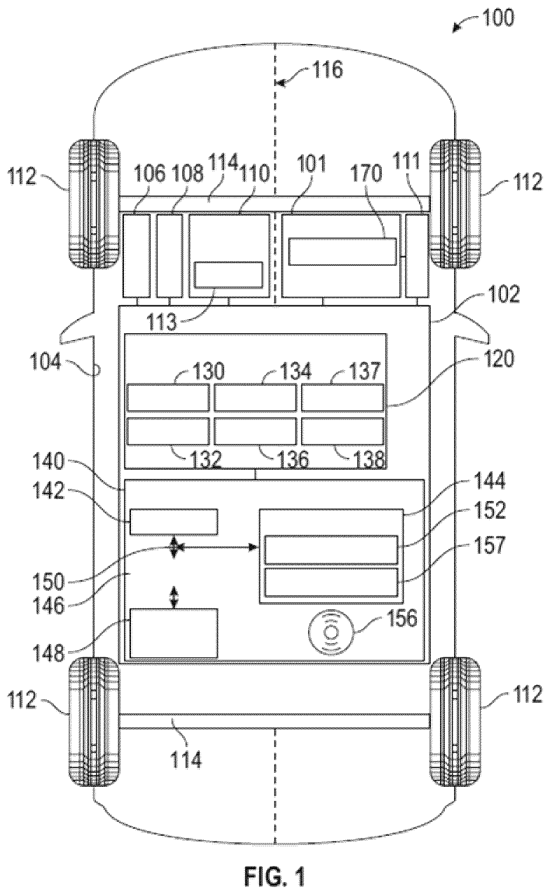

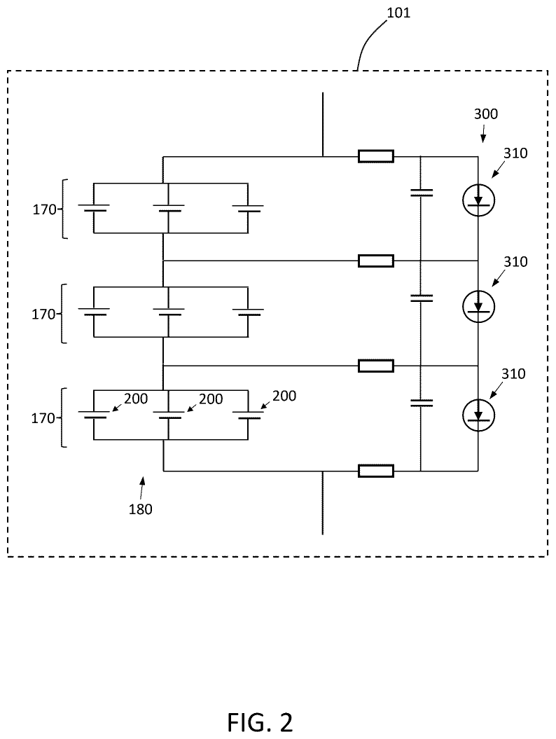

FIG. 1 illustrates a vehicle 100, according to an exemplary implementation. As described in greater detail further below, the vehicle 100 includes, among other components, a rechargeable energy storage system (“RESS”) or battery system 101 and a control system 102. In various implementations, the RESS 101 includes a plurality of cell groups 170, for example as depicted in FIG. 2 and described in greater detail further below in connection therewith. Also in various implementations, the control system 102 controls the RESS 101.

As depicted in FIG. 1, the RESS 101 and control system 102 are depicted as part of the vehicle 100 in accordance with exemplary implementations. In various implementations, the vehicle 100 comprises an automobile, such as any one of a number of different types of automobiles, such as, for example, a sedan, a wagon, a truck, sport utility vehicle (SUV), or the like. In certain implementations, the vehicle 100 may also comprise a motorcycle or other vehicle, such as aircraft, spacecraft, watercraft, and so on, and/or one or more other types of mobile platforms (e.g., a robot and/or another mobile platform). In yet other implementations, the RESS 101 and control system 102 may instead be part of and/or coupled to any number of other types of platforms and/or other systems, moving or non-moving, such as a building, infrastructure, secondary use, home power, non-automotive, and/or other platforms and/or other systems.

In the depicted implementation, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one implementation, the vehicle 100 includes four wheels 112, although this may vary in other implementations (for example for trucks, motorcycles, and certain other vehicles).

A drive system 110 is mounted on the chassis 116, and drives the wheels 112, for example via axles 114. In certain implementations, the drive system 110 comprises a propulsion system having an electric motor 113. In various implementations, the drive system 110, including the motor 113, receives high voltage from the RESS 101.

In various implementations, in addition to providing the high voltage to the motor 113, the RESS 101 also provides low voltage to one or more low voltage systems 111 of the vehicle 100. In various implementations, the low voltage systems 111 may include, by way of example, one or more climate control systems, radio systems, seat warming systems, and so on.

As depicted in FIG. 1, the vehicle also includes a braking system 106 and a steering system 108 in various implementations. In exemplary implementations, the braking system 106 controls braking of the vehicle 100 using braking components that are controlled via inputs provided by a driver (e.g., via a brake pedal) and/or automatically via a control system (such as the control system 102 and/or one or more other control systems). Also in exemplary implementations, the steering system 108 controls steering of the vehicle 100 via steering components that are controlled via inputs provided by a driver (e.g., via a steering wheel), and/or automatically via a control system (such as the control system 102 and/or one or more other control systems).

In the implementation depicted in FIG. 1, the control system 102 is coupled to the RESS 101, receives inputs therefrom, and controls functionality thereof. In addition, in certain implementations, the control system 102 is coupled to one or more of the braking system 106, steering system 108, drive system 110, and/or low voltage systems 111, and may also receive inputs from and/or control these additional systems in certain implementations.

Also as depicted in FIG. 1, in various implementations, the control system 102 includes a sensor array or arrangement 120 and a control module 140 (or controller), as described in greater detail below.

In various implementations, the sensor array 120 includes various sensors that obtain sensor data of the vehicle 100 for use in controlling, among other functionality, the RESS 101. In the depicted implementation, the sensor array 120 includes one or more voltage sensors 130, current sensors 132, temperature sensors 134, hydrogen sensors 136, pressure sensors 137, and additional sensors 138.

In certain implementations, the voltage sensors 130 measure voltage of the RESS 101, including of the various cell groups 170 thereof. Also in certain implementations, the current sensors 132 measure electric current of the RESS 101, including of battery cells 200 (shown in FIG. 2) or of the cell groups 170 thereof. In various implementations, the temperature sensors 134 measure temperature of the RESS 101, including of battery cells 200 (shown in FIG. 2) or of the cell groups 170 thereof. In addition, various implementations, the pressure sensors 137 measure the pressure within a battery cell 200 (shown in FIG. 2) or within a cell group 170 of the RESS 101. Further, additional sensors 138 may monitor or measure one or more other parameters pertaining to conditions within a battery cell 200 (shown in FIG. 2) or within a cell group 170 of the RESS 101.

In various implementations, the control module 140 is coupled to the sensor array 120 and receives sensor data therefrom. In various implementations, the control module 140 is further coupled to the RESS 101. In addition, in certain implementations, the control module 140 may also be coupled to one or more other systems of the vehicle 100, such as the braking system 106, steering system 108, drive system 110, and/or low voltage systems, for example for receiving input thereof and/or for controlling thereof.

As depicted in FIG. 1, in various implementations, the control module 140 comprises a computer system, and includes a processor 142, a memory 144, an interface 146, a storage device 148, and a computer bus 150.

The processor 142 performs the computation and control functions of the control module 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the control module 140 and the computer system of the control module 140, generally in executing the processes described herein.

The memory 144 can be any type of suitable memory, including various types of non-transitory computer readable storage medium. In certain examples, the memory 144 is located on and/or co-located on the same computer chip as the processor 142. In the depicted implementation, the memory 144 stores the above-referenced program 152 along with stored values 157 (e.g., look-up tables, thresholds, and/or other values with respect to control of the RESS 101).

The interface 146 allows communication to the computer system of the control module 140, for example from a system driver and/or another computer system, and can be implemented using any suitable method and apparatus. In one implementation, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

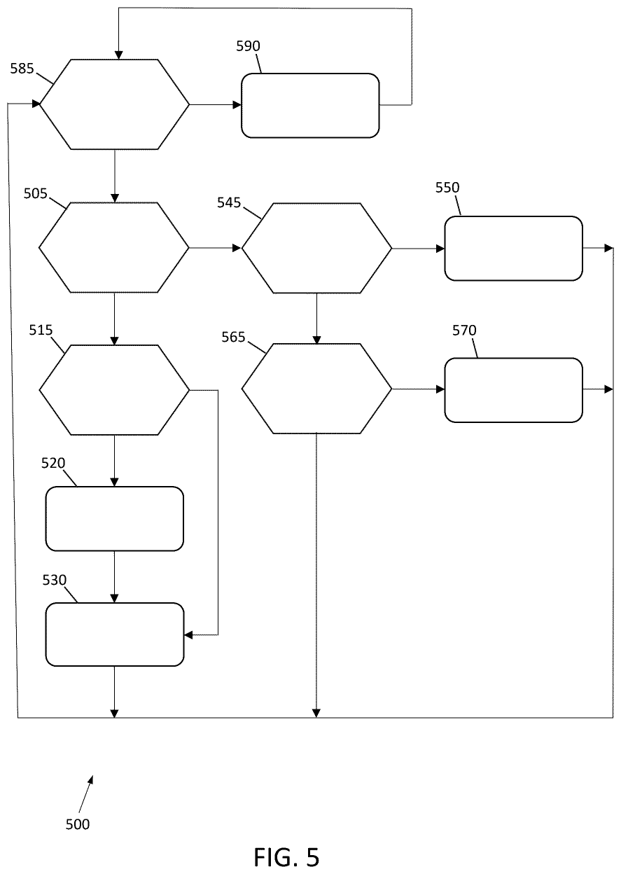

The storage device 148 can be any suitable type of storage apparatus, including various different types of direct access storage and/or other memory devices. In one exemplary implementation, the storage device 148 comprises a program product from which memory 144 can receive a program 152 that executes one or more implementations of one or more processes of the present disclosure, such as the steps of the method 500 of FIG. 5 and described further below in connection therewith. In another exemplary implementation, the program product may be directly stored in and/or otherwise accessed by the memory 144 and/or a disk (e.g., disk 156).

The bus 150 serves to transmit programs, data, status and other information or signals between the various components of the computer system of the control module 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary implementation is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program.

FIG. 2 is a functional diagram of a portion of the RESS 101 of FIG. 1, such as a battery module or system.

As depicted in FIG. 2, in various implementations, the RESS or battery system 101 includes a number of cell groups 170. Each cell group 170 includes at least one battery cell 200. In FIG. 2, each cell group 170 includes three battery cells 200 arranged in parallel. Other arrangements are contemplated. For example, cell groups 170 may include fewer battery cells 200, such as one or two battery cells 200, or more battery cells 200. In other words, the number of battery cells 200 per cell group 170 may be any desired suitable number.

In certain embodiments, the battery cells 200 may be arranged in series in a stack 180. Any desired number of cell groups 170 may be configured electrically in series to provide a desired DC voltage level and/or DC output current. Thus, it will be appreciated that the number and configuration of cell groups 170 and battery cells 200 may vary in different implementations, and the subject matter described herein is not limited to any particular number, type or configuration of cell groups 170 or battery cells 200. The battery system 101 may be connected to the drive system 110 of FIG. 1, such as via a bus bar.

As shown in FIG. 2, the battery system 101 further includes a diode arrangement 300. Specifically, each battery cell group 170 is electrically connected in parallel to a respective diode 310.

As shown, resistors 220 may be electrically connected between the battery cell groups 170 and dedicated diodes 310. Further, capacitors 230 may be connected in parallel with the battery cell groups 170. The capacitors 230 may be used to smooth out cell voltage measurement, filter out voltage spikes, improve harmonics of the battery system 101, etc.

Each diode 310 is forward biased to conduct current from the positive terminal to the negative terminal of each respective battery cell group 170 through the diode 310 when the battery cell group 170 provides the voltage necessary to overcome the diode's forward voltage drop. In embodiments herein, during typical operation each battery cell group 170 has sufficient voltage to continuously overcome the diode's forward voltage drop, thus the current from the positive terminal to the negative terminal of each respective battery cell group 170 is continuous. For example, diodes 310 having a forward voltage drop less than the minimum operating voltage of the battery cells 200 may be used.

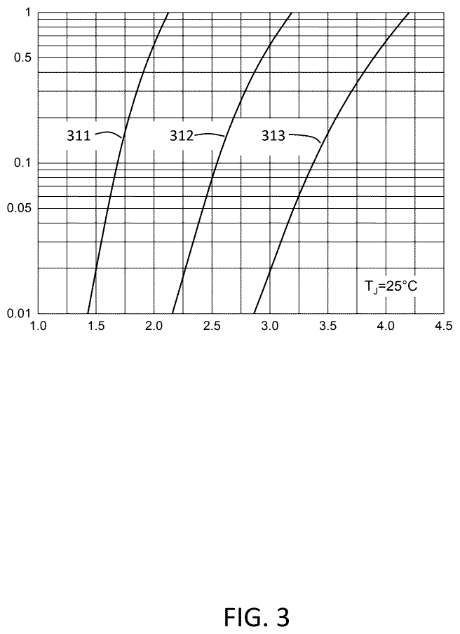

FIG. 3 is a graph showing the instantaneous forward characteristics of three different diodes 311, 312, and 313 at a constant temperature of 25 degrees C. In FIG. 3, the x-axis is the instantaneous voltage measured in volts, and the y-axis is the instantaneous forward current measured in amps. As shown, the graph uses a linear-log scale, i.e., the x-axis is in linear scale while the y-axis is in logarithmic scale. Thus, current-voltage (I-V) curves are provided for each diode 311, 312, and 313. While the graph illustrates characteristics of three diodes 311, 312, and 313, diodes 310 may be selected from any suitable diodes and are not limited to selection from diodes 311, 312, and 313. It is noted that within a battery system 101 or within a battery cell group 170, all diodes 310 are the same, i.e., all diodes 310 have the same I-V curve.

As generally indicated in the graph, for each diode, as the voltage applied increases, the current passing through the diode increases exponentially. For example, for diode 313, at 3.25 volts, about 0.06 amps flow, while at 4 volts about 0.66 amps flow. Thus, an increase in voltage of less than 25% led to an increase in current of about 1000%.

Diodes may be designed with selected I-V curves. Further, diodes with desirable properties or behavior at selected voltages may be selected for use in the system 101.

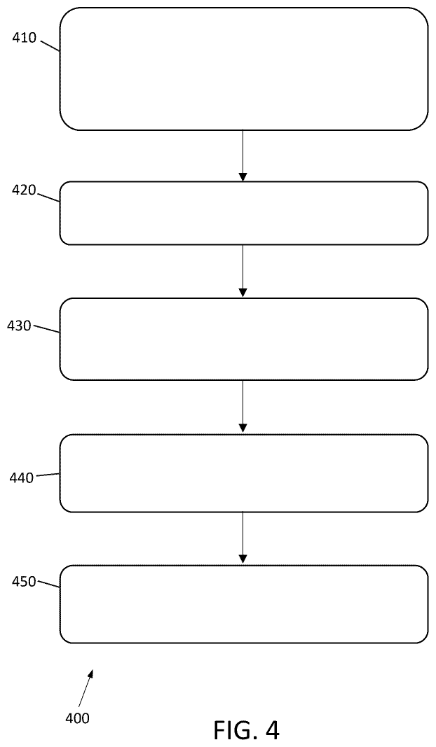

FIG. 4 is a flow chart of a method 400 for designing operation of a diode arrangement 300 and battery system 101 for cell balancing. Method 400 includes the selection of diodes 310 for use in the system 101 based on the characteristics of the battery system 101 and the diodes 310.

For example, the battery cells 200 have a capacity, measured in ampere-hours (Ah) of from 3 Ah to 5 Ah, or from 50 to 100 Ah, depending on the cell design. In certain embodiments, the capacity of the battery cells may be used as a factor when selecting a diode for use with the system 101.

Further, the battery system 101 has a maximum operating voltage. The maximum operating voltage is the highest voltage at which the battery cells are intended to operate safely and effectively under normal use conditions, including during charging and discharging. The maximum operating voltage is observed as an overall safety limit of the battery during any phase of its operation, and ensures that no component or safety system is stressed beyond its design limits. In lithium-ion batteries, exceeding this voltage can lead to degradation, safety issues, or even catastrophic failure.

The typical maximum operating voltage for lithium-ion batteries may be about 4.2 volts per cell. More specifically, for Nickel Manganese Cobalt (NMC) cells, the maximum operating voltage is generally around 4.2 volts per cell, and for Lithium Iron Phosphate (LiFePO4 or LFP) cells, the maximum operating voltage may be around 3.6 volts per cell.

In certain embodiments, the maximum operating voltage may be used as a factor when selecting a diode for use with the system 101.

The maximum operating voltage may be analogous to a maximum cell voltage rating, which is typically indicated by the battery manufacturer as the point at which charging should stop to maintain battery health. In other words, the maximum cell voltage rating is the manufacturer's specified upper voltage limit for a cell. This rating indicates the absolute maximum voltage the cell should be subjected to, often under any circumstance, to prevent damage or failure. It encompasses both the maximum voltage during operation and any protective measures or safety margins included in the cell's design. In certain embodiments, the maximum cell voltage rating may be used as a factor when selecting a diode for use with the system 101.

The maximum operating voltage and/or maximum cell voltage rating may be considered when determining a charge termination voltage for a battery. The charge termination voltage refers to the specific voltage level at which the charging process of a battery is stopped to prevent overcharging. Charging to the charge termination voltage ensures that the battery cells are fully charged but not overcharged, which could lead to degradation, thermal runaway, or other safety issues. Charge termination at the set limit is crucial for maintaining battery health, longevity, and safety. In certain embodiments, the charge termination voltage may be equal to the maximum operating voltage, though typically the charge termination voltage is slightly lower than the maximum operating voltage to account for potential voltage spikes or inaccuracies in measurement. In certain embodiments, the charge termination voltage may be used as a factor when selecting a diode for use with the system 101.

The open circuit voltage of a battery is the voltage of the battery when the battery is not connected to any load or charge, i.e., at its rest state. The open circuit voltage may be different from the voltage measured during charging or discharging because it reflects the battery's state without the influence of current flow. In certain embodiments, the charge termination open circuit voltage, i.e., the open circuit voltage at charge termination, may be used as a factor when selecting a diode for use with the system 101.

In addition to the various upper limits described above, batteries also may have a minimum operating voltage. The minimum operating voltage refers to the lowest voltage at which a battery can still provide power to operate a device or system effectively. This voltage is the point below which the performance of the device using the battery might degrade significantly, or the battery might no longer be able to deliver the power needed for normal operation. Discharging a battery cell below the minimum operating voltage can cause irreversible damage to the cell, reducing its capacity and shortening its lifespan.

For lithium-ion batteries, the minimum operating voltage is generally around 3.0 volts per cell. Specific battery cell chemistries might have slightly different minimum operating voltages. For example, lithium iron phosphate (LiFePO₄) batteries may have a minimum operating voltage of from 2.5 to 2.8 volts per cell, while lithium cobalt oxide (LiCoO₂), nickel manganese cobalt (NMC), and lithium manganese oxide (LMO) may have a minimum operating voltage of about 3.0 volts. In certain embodiments, the minimum operating voltage may be used as a factor when selecting a diode for use with the system 101.

Related to the minimum operating voltage is the minimum safe discharge voltage (sometimes referred to as “cut-off voltage” in battery management systems). The minimum safe discharge voltage is the voltage level at which the battery should be considered fully discharged or where further discharging could harm the battery. This voltage is set to protect the battery from over-discharge, which could lead to irreversible damage, reduced capacity, or safety issues like cell reversal in multi-cell batteries. In certain embodiments, the minimum safe discharge voltage or cut-off voltage may be used as a factor when selecting a diode for use with the system 101.

While battery cells may generally perform well while being charged and discharged in the range between their upper and lower limits, other voltages may be of interest. For example, battery cells of certain chemistries may degrade faster at full charge because of side reactions that occur more readily at higher voltages. These reactions can lead to capacity loss over time. Therefore, batteries may be stored at lower charge levels to enhance longevity. As used herein, a target charge level may be determined for a battery or battery cells as being optimal for providing long-term battery health. The target charge level may be expressed in terms of State of Charge (SOC) as a percentage. Alternatively, the open circuit voltage at the target charge level, i.e., the target charge level open circuit voltage, may be used.

Further, the target charge level or target charge level open circuit voltage may be different depending on the planned use of the vehicle. For example, when use is not planned for a long period of time, such as a month or longer, the target charge level or target charge level open circuit voltage may be set at a lower level as compared to when used is not planned for an overnight period. In certain embodiments, the target charge level or target charge level open circuit voltage, or ranges thereof, may be used as a factor when selecting a diode for use with the system 101.

In view of the above characteristics, a diode may be selected for use in the system 101 based on its behavior as reflected by its I-V curve. Specifically, cell balancing performance will benefit from a diode having relatively steep I-V curve when increasing up to the upper limit voltage. Further, maintaining the battery above the lower limit voltage will be facilitated by a diode having a relatively flat I-V curve and/or a low current value when decreasing to the lower limit voltage. Also, maintaining a battery at an optimized charge level may be facilitated by a diode having a relatively flat I-V curve and/or low current value at and around the target charge level open circuit voltage.

For example, referring to FIG. 3, for battery cells having a minimum operating voltage of 3.0 volts per cell and a maximum operating voltage of 4.2 volts per cell, diode 313 may provide superior performance as compared to diodes 311 and 312, as the I-V curve of diode 313 indicates that a relatively small current would drain the battery cell at a voltage of 3.0 volts, while a relatively large current would drain the battery cell at a voltage of 4.2 volts.

A further consideration is that each battery cell 200 has a self-discharge rate and current. Unlike the upper limit and lower limit voltages above, each battery cell 200 has its own self-discharge rate, i.e., each self-discharge rate may be unique.

The self-discharge rate of a battery cell refers to the rate at which the battery cell loses its charge when not in use, essentially the rate at which its state of charge and/or capacity decreases over time due to internal chemical reactions or other factors, such as internal shorts from small dendrite growth of lithium, bridging anode and cathode, even without any external load. The related self-discharge current is the resulting constant current that drains the battery cell over time. The self-discharge current of a battery cell is typically on the order of microamperes (μA) or even lower, depending on the battery's capacity and chemistry.

The difference in self-discharge rates between battery cells 200 in cell groups 170 in a battery stack 180 may lead to the cell groups 170 being so out of balance that the battery stack 180 cannot discharge to drive a current or be charged. For example, over time a first battery cell having the highest self-discharge rate may be drained to near the lower voltage limit, while a second battery cell having the lowest self-discharge rate may be near the upper voltage limit. The battery system will be limited when discharging when the first battery cell reaches the lower voltage limit and will be limited when charging when the second battery cell reaches the upper voltage limit.

Embodiments herein are provided to balance battery cells to avoid such a scenario. Embodiments first determine whether battery cells need to be balanced, such as by comparing battery cell voltages within a battery stack. When a difference between battery cell voltages reaches a threshold, the battery cells are determined to be out of balance or in need of balancing.

Further, embodiments herein provide for charging the battery cells to an optimal cell balancing window, repeatedly, if necessary, to reduce the difference in battery cell voltages. The upper voltage limit of the cell balancing window, specified as an upper voltage limit V₁, may be or may be based on the maximum operating voltage, maximum cell voltage rating, charge termination voltage, or charge termination open circuit voltage.

After a battery charge process is performed, one battery cell may be charged to the upper voltage limit V₁, while other battery cells may be charged to a lower voltage, i.e., charging may be ceased when the highest charged battery cell, such as the battery cell with the lowest self-discharge rate, reaches the upper voltage limit. Then, battery cells 200 may be slowly drained by the diodes 310.

Embodiments herein determine a lower voltage limit V₂ for the cell balancing window. The lower voltage limit V₂ may be based on the upper voltage limit V₁, such as being selected as a percentage of the upper voltage limit V₁, selected as being a maximum value less than the upper voltage limit V₁, or may be selected based on diode behavior.

The lower voltage limit V₂ represents a lower threshold below which the battery system may re-activate a charging process. Therefore, while the voltages of the battery cells are reduced by the currents draining through the diodes, the least charged battery cell, such as the battery cell with the highest self-discharge rate, will reach the lower voltage limit V₂. When the lower voltage limit V₂ is reached by the least charged battery cell, the system begins another charging process that continues until the highest charged battery cell reaches the upper voltage limit V₁.

As indicated by the I-V curve of the diodes in FIG. 3, the discharge current passing through the diodes is higher at higher voltages. Therefore, each time a charge process is completed and a highest charged battery cell is at the upper limit, that highest charged battery cell is drained by its respective diode more quickly than all of the other battery cells. Likewise, the lowest charged battery cells is drained by its respective diode more slowly that all of the other battery cells. In this manner, the spread between battery cell voltages is reduced, and the cell voltages are balanced over time.

When selecting upper voltage limit V₁ and lower voltage limit V₂, the following equations may be used:

$${I}_{Diode {V}_{1}} > {I}_{SD} + {I}_{Diode V 2}$$

$${V}_{2} = {V}_{1} - {V}_{Nominal Spread}$$

wherein, I_{DiodeV1} is the current through each diode at the upper voltage limit V₁;
wherein, I_{DiodeV2} is the current through each diode at the lower voltage limit V₂;
wherein, Isp represents the greatest difference in self-discharge current between a battery cell at upper voltage limit V₁ and a battery cell at lower voltage limit V₂;
wherein, upper voltage limit V₁ and lower voltage limit V₂ represent the cell balancing window limits within which all battery cells will be when the battery is at the battery maximum operating voltage, i.e., an allowable cell voltage spread at top end of battery charge; and
wherein, V_{Nominal Spread} is the selected difference between upper voltage limit V₁ and lower voltage limit V₂.

A target charge level circuit voltage V₃, i.e., a selected voltage at which the battery cells should be stable and preserve battery life, may be set at a desired percentage, such as 50%, according to the equation:

$${I}_{Diode 3} < \frac{Capacity ( Ahrs )}{24 ( hrs / day )} * \frac{{SOC}_{loss} ( unitless decimal )}{day}$$

wherein, I_{Diode V}_{₃} is the current through each diode at the target voltage V₃.

As described above, a lower I_{Diode3} prevents the battery system from draining too quickly if idle for extended time periods.

In view of the above, method 400 for designing operation of a diode arrangement 300 and battery system 101 for cell balancing may include, at operation 410, identifying the capacity, maximum operating voltage, maximum cell voltage rating, charge termination voltage, charge termination open circuit voltage, minimum operating voltage, minimum safe discharge voltage, target charge level, and/or target charge level open circuit voltage or the battery system, battery stack, and/or battery cells.

Method 400 may further include selecting an upper voltage limit for a cell balancing window based on the above at operation 420. In certain embodiments, the upper voltage limit is determined as a constant voltage setpoint of the upper window limit.

Further, method 400 may include, at operation 430, selecting a diode with a suitable I-V curve, i.e., with a voltage and current relationship that provides a sufficiently high current at the upper voltage limit of the cell balancing window and a sufficiently low current at the minimum operating voltage or minimum safe discharge voltage. In certain embodiments, optional additional circuitry may be provided between the diode and respective cell, such as resistors and/or capacitors. Resistors may be included to further refine the peak current pulled during balancing. This is in addition to the resistors and capacitors being in place for cell voltage measurement (smoothing, filtering harmonics, etc.). The inclusion of resistors and/or capacitors between the diode and respective cell will adjust the effective current going through the diode at V₁, V₂, and V₃, considering the diode properties and other optional hardware (i.e., resistors) in line with it.

Further, method 400 may include, at operation 440, selecting a lower voltage limit V₂ for the cell balancing window. In certain embodiments, the lower voltage limit V₂ is determined as an optimal voltage setpoint of the lower window limit. The lower voltage limit V₂ may be selected based the current of the diode at the lower voltage limit, based on the anticipated discharge rate though the diodes from the upper voltage limit downward to the lower voltage limit, based on the amount of time needed to discharge the battery cells through the diodes from the upper voltage limit downward to the lower voltage limit, or on other operational factors. As noted above, the diode current at the upper voltage limit V₁ should be greater than the sum of the diode current at the lower voltage limit V₂ and the greatest difference in self-discharge current between a battery cell at upper voltage limit V₁ and a battery cell at lower voltage limit V₂.

The method 400 may include, at operation 450, selecting a charge time for the charging operation during cell balancing. For example, while charging may be performed until the highest charged cell reaches the upper voltage limit, in other embodiments, the charging process may be performed for a set period of time.

As described above, the battery system 101 provided with the diode arrangement 300 of diodes 310 will passively balance the voltages of battery cells through the inherent behavior of the diodes passing higher currents at higher voltages. However, methods are provided to optimize or accelerate the cell balancing process.

For example, FIG. 5 is a flow chart of such a method 500 for performing cell balancing. In certain embodiments, the method 500 is automated, i.e., performed automatically by control system or controller 102.

As shown, method 500 may include, at query 585, determining whether active support of cell balancing through reiterative charging is time appropriate.

For example, determining whether active support of cell balancing through reiterative charging is time appropriate may include determining whether an imminent use of the vehicle is anticipated, scheduled or otherwise known. If so, then query 585 determines not time appropriate.

For example, the controller may monitor use of the vehicle and anticipate that the vehicle will not be driven at a certain time of day, such as between midnight and 6 am. Thus, the controller may determine at 5:55 am that an imminent use of the vehicle is anticipated based on time-of-day usage and that active support of cell balancing through reiterative charging is not time appropriate. Alternatively, a user may input an intended next use or a schedule of use or planned operation.

Also, query 585 may consider grid demand forecasts. Specifically, a time of high grid demand may be classified as not time appropriate.

When the controller determines that active support of cell balancing through reiterative charging is not time appropriate, then method 500 may continue at operation 590 by delaying active support of cell balancing through reiterative charging. Further, operation 590 may include preparing for use of the vehicle if imminent. For example, the controller may bring the vehicle to a programed temperature or location, and/or may charge the battery to a desired voltage.

In the case of an imminent use of the vehicle, active support of cell balancing processes of method 500 may be delayed because the actual use of the vehicle will involve charging and discharging the battery cells, including to within the cell balancing window where the diodes will perform passive cell balancing.

In the case of high electrical grid demand, active support of cell balancing processes of method 500 may be delayed until electrical grid demand lessens.

When the controller determines at query 585 that active support of cell balancing through reiterative charging is time appropriate, method 500 may continue at query 505.

As shown, method 500 may include, at query 505, determining whether there is a need to balance the voltages of the battery cells or to balance the State of Charge (SOC) of the battery cells. In certain embodiments, the controller makes this determination by monitoring the cell voltages or SOC within a battery stack. When a greatest difference in cell voltages (or voltage spread) or greatest difference in SOC within a battery stack reaches a threshold difference value, the controller determines that there is a need to balance, i.e., that the battery cell voltages or SOC are out of balance.

Additionally or alternatively, the controller determines whether there is a need to balance the voltages or SOC of the battery cells based on the amount of current throughput since the last cell balancing operation. For example, the controller may monitor the amount of current that has been output by the battery stack or battery, and when the amount of current throughput reaches a threshold value, the controller determines that there is a need to balance.

Additionally or alternatively, the controller determines whether there is a need to balance the voltages or SOC of the battery cells based on the duration of time since the last cell balancing operation. For example, the controller may monitor the time that has passed, and when the amount of time reaches a threshold value, the controller determines that there is a need to balance.

When the controller determines that there is a need to balance, method 500 continues at query 515 which determines whether the voltages of the cells are above the lower voltage limit V₂ of the cell balancing window. Query 515 may include considering any one cell voltage, all cell voltages, or an average cell voltage when making the determination of when the cell voltages are above the lower voltage limit.

When query 515 finds that the voltages of the cells are not above the lower voltage limit V₂ of the cell balancing window, then method 500 may continue at operation 520. At operation 520, method 500 includes performing a charge process to charge the battery cells to the upper voltage limit V₁ of the cell balancing window. In certain embodiments, the charge process ceases when a highest charged battery cell reaches the upper voltage limit. As mentioned above, the charge process may alternatively be performed for a set duration of charge time.

Method 500 may then continue at operation 530 where the diodes continue to passively drain the battery cells and no charging process is performed. It is understood that the diodes are passively draining the cells continuously, including before and after operation 530, and at operation 530 they are in the optimal condition (voltage range) to balance the cells in the quickest manner.

As shown in FIG. 5, method 500 then may return to query 585 and then query 505 to determine whether there is a need to balance. When the initial cell voltage spread is too large to be minimized to within the threshold voltage difference value with a single charge/drain process, query 505 will continue to determine that there is a need to balance. At query 515, following or during a charge process, it may be found that the voltages of the cells are above the lower voltage limit V₂ of the cell balancing window. As a result, the method 500 then proceeds directly to operation 530 wherein the diodes are allowed to continue to drain the battery cells, without instigating a new charge process at operation 520.

In this manner, queries 505 and 515 and operations 520 and 530 may iteratively perform cell balancing until there is no longer a need to balance.

When at query 505, the controller determines that there is no need to balance the voltages of the cells, method 500 continues at query 545.

At query 545, the controller determines whether the voltage or state of charge (SOC) of the battery or battery stack is above the target charge level or target charge level circuit voltage V₃.

When the controller determines that the voltage or state of charge (SOC) of the battery or battery stack is above the target charge level or target charge level circuit voltage V₃ at query 545, then the method 500 continues at operation 550 with actively discharging the battery to position the battery or battery stack at the target charge level or target charge level circuit voltage V₃.

After discharging the battery to the target charge level or target charge level circuit voltage V₃, then the method 500 may continue at query 585 and then query 505.

When the controller determines that the voltage or state of charge (SOC) of the battery or battery stack is not above the target charge level or target charge level circuit voltage V₃ at query 545, then the method 500 continues at query 565.

At query 565, the controller determines whether the voltage or state of charge (SOC) of the battery or battery stack is near or at the minimum operating voltage or minimum SOC. In certain embodiments, the controller makes this determination by monitoring the cell voltages within a battery stack. Query 565 may include considering any one cell voltage.

When the controller determines that the voltage or state of charge (SOC) of the battery or battery stack is near or at the minimum operating voltage or minimum SOC at query 565, then method 500 continues at operation 570.

At operation 570, the controller performs a charging process. For example, the charging process may charge the battery to a desired charge termination SOC. Then, method 500 may continue at query 585 and then query 505.

When the controller determines that the voltage or state of charge (SOC) of the battery or battery stack is not near or at the minimum operating voltage or minimum SOC at query 565, then method 500 may continue at query 585 and then query 505.

Query 565 and operation 570 provide for periodically charging the battery system to keep the battery system within a band close to the desired charge termination or SOC. This is needed because the diodes will continually drain the cells in the pack.

As described herein, method 500 provides for iteratively charging the battery to an upper voltage limit of a cell balancing window to optimize the difference in diode draining currents to more quickly reduce the voltages of the highest cell voltages, relative to lower cell voltages. When the method 500 determines that the cell voltages are out of balance and the cell voltage drops below the lower voltage limit of the window, the method automatically charges the battery back to the upper voltage limit of the window. In this manner, the time that the cell voltages remain in the optimized cell balancing voltage window is increased. In other words, embodiments herein charge a battery system to optimal voltages to drive the highest differential in diode current between the maximum and minimum cells in the system, until the system is brought into an acceptable balance.

Further, the method provides for, after balancing the cell voltages, discharging the battery stack to a target charge level optimized for storage and battery health.

Also, as the diodes are designed to continuously discharge the battery cells, the method includes monitoring the cell voltages with respect to the minimum operating voltage and charging the battery to avoid allowing any battery cell to reach the minimum operating voltage when needed.

As noted above, high grid demand may be considered when determining whether to actively support cell balancing through reiterative charging. For example, actively supporting cell balancing through reiterative charging may be delayed when the demand for energy is high.

Further, other conditions of Electric Vehicle Supply Equipment (EVSE) may be considered when determining whether it is time appropriate to actively support cell balancing through reiterative charging.

In addition, the intended future use of the vehicle may be considered when determining whether to actively support cell balancing through reiterative charging.

Embodiments herein include one or more diodes, resistors, and capacitors connected to a single or group of cells for cell balancing in a passive manner. In certain embodiments, multiple diodes may be used with different levels of resistors in series to fine tune an expected balance current vs voltage.

Certain embodiments herein include a circuit to a battery cell including only a diode. Additional resistors and capacitors are optional and not mandatory in any embodiment. Resistors may further tune the effective draining current through the diode via adding more resistance and lowering the current. For cell voltage sensing, resistors and capacitors can be used to smooth out voltage spikes and tune harmonics to allow better cell voltage sensing.

Certain embodiments includes tuning the diodes to a constant-voltage charge setpoint value. Certain embodiments include tuning the diodes to a post-charge-complete open circuit voltage value.

In certain embodiments, charging constant-voltage time is extended to increase cell balancing time. Specifically, cell voltages are monitored so that when the cell voltages drop below the optimal voltage range, they may be charged to a voltage level within the optimal voltage range.

Embodiments herein may be provided at a lower cost and less complexity than systems using active cell balancing with circuit balancing gates. Embodiments herein contain no balancing gates and are not prone to calibration or cell level sensing errors. This allows for a design with fewer parts, thus reducing cost and reducing failure points. The overall package of the diode cell balancing circuit may also be physically smaller than current active cell balancing systems.

It will be appreciated that the systems, vehicles, and methods may vary from those depicted in the Figures and described herein. It will similarly be appreciated that the steps of the methods may differ from that depicted in the Figures, and/or that various steps of the methods may occur concurrently and/or in a different order than that depicted and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A battery system comprising:
battery cell groups connected electrically in series in a battery stack, wherein:
each battery cell group has a desired cell balancing window defined between an upper limit voltage V₁ and a lower limit voltage V₂;
each battery cell group has a minimum idle voltage V₃;
$${V}_{1} > {V}_{2} > {V}_{3} ;$$
each battery cell group comprises at least one battery cell; and
each battery cell independently has a self-discharge current less than or equal to a maximum self-discharge current I_{SD}; and
a diode arrangement configured to passively reduce a difference in voltage between battery cell groups, wherein:
the diode arrangement comprises diodes;
each diode is connected electrically in parallel with a respective battery cell group;
each diode is configured to drain the respective battery cell group with a same first diode current I_{D1} at voltage V₁, with a same second diode current I_{D2} at voltage V₂, and with a same third diode current I_{D3} at voltage V₃;
$${I}_{D 1} > {I}_{D 2} > {I}_{D 3} > 0 ; and$$
$${I}_{D 1} > {I}_{D 2} + {I}_{SD} .$$

2. The battery system of claim 1, further comprising resistors connected between the battery cell groups and respective diodes.

3. The battery system of claim 1, further comprising a controller configured to drive cell group balancing by:
determining that the battery cell groups need to be balanced; and
charging the battery stack to a specified voltage when the battery cell groups need to be balanced.

4. The battery system of claim 3, wherein the controller determines that the battery cell groups need to be balanced based on a difference in State of Charge (SOC) and/or a difference in Voltage.

5. The battery system of claim 3, wherein the specified voltage is selected from a maximum cell voltage rating, a charge complete open circuit voltage, and charge voltage clamp.

6. The battery system of claim 3, wherein the controller is configured to:
determine that the battery cell groups are in balance; and
cease charging of the battery stack to allow the battery cell groups to drain when the battery cell groups are in balance.

7. The battery system of claim 3, wherein the controller is configured to:
determine that the battery cell groups are in balance; and
cease charging of the battery stack and discharge the battery stack to a target charge level when the battery cell groups are in balance.

8. The battery system of claim 7, wherein the target charge level is less than the specified voltage.

9. The battery system of claim 7, wherein the controller is configured to:
determine that the battery stack is below a threshold SOC; and
charge the battery stack when the battery stack is below the threshold SOC.

10. The battery system of claim 3, wherein the controller is configured to:
identify whether use of the battery system is imminent; and
when use of the battery system is imminent, delaying cell group balancing.

11. A vehicle comprising:
an electric motor configured to provide motive torque; and
a battery system operatively connected to the electric motor and operable to provide electrical power to the electric motor, wherein the battery system comprises:
a high voltage rechargeable battery including battery stacks comprising battery cell groups, wherein:
each battery cell group has a desired cell balancing window defined between an upper limit voltage V₁ and a lower limit voltage V₂;
each battery cell group has a minimum idle voltage V₃;
$${V}_{1} > {V}_{2} > {V}_{3} ;$$
and
each battery cell group comprises at least one battery cell; and
each battery cell independently has a self-discharge current less than or equal to a maximum self-discharge current I_{SD}; and
a diode arrangement configured to passively reduce a difference in voltage between battery cell groups, wherein:
the diode arrangement comprises diodes;
each diode is connected electrically in parallel with a respective battery cell group;
each diode is configured to drain the respective battery cell group with a same first diode current I_{D1} at voltage V₁, with a same second diode current I_{D2} at voltage V₂, and with a same third diode current I_{D3} at voltage V₃;
$${I}_{D 1} > {I}_{D 2} > {I}_{D 3} > 0 ; and$$
$${I}_{D 1} > {I}_{D 2} + {I}_{SD} .$$

12. The vehicle of claim 11, wherein the battery system further comprises a controller configured to drive cell group balancing by:
determining that battery cell groups in a battery stack need to be balanced; and
charging the respective battery stack to a specified voltage when the battery cell groups need to be balanced.

13. The vehicle of claim 12, wherein the controller is configured to:
determine that the battery cell groups in the respective battery stack are in balance; and
cease charging of the respective battery stack to allow the battery cell groups to drain when the battery cell groups are in balance.

14. The vehicle of claim 12, wherein the controller is configured to:
determine that the battery cell groups in the respective battery stack are in balance; and
cease charging of the respective battery stack and discharge the respective battery stack to a target charge level when the battery cell groups are in balance.

15. The vehicle of claim 12, wherein the controller is configured to:
determine that the respective battery stack is below a threshold SOC; and
charge the battery stack when the battery stack is below the threshold SOC.

16. A method for cell balancing a battery, the method comprising:
connecting battery cell groups electrically in series in a battery stack, wherein:
each battery cell group has a desired cell balancing window defined between an upper limit voltage V₁ and a lower limit voltage V₂;
each battery cell group has a minimum idle voltage V₃;
$${V}_{1} > {V}_{2} > {V}_{3} ;$$
and
each battery cell group comprises at least one battery cell;
each battery cell independently has a self-discharge current less than or equal to a maximum self-discharge current I_{SD}; and
interconnecting a diode arrangement with the battery cell groups, wherein the diode arrangement is configured to passively reduce a difference in voltage between battery cell groups, wherein:
the diode arrangement comprises diodes;
each diode is connected electrically in parallel with a respective battery cell group;
each diode is configured to drain the respective battery cell group with a same first diode current I_{D1} at voltage V₁, with a same second diode current I_{D2} at voltage V₂, and with a same third diode current I_{D3} at voltage V₃;
$${I}_{D 1} > {I}_{D 2} > {I}_{D 3} > 0 ; and$$
$${I}_{D 1} > {I}_{D 2} + {I}_{SD} .$$

17. The method of claim 16, further comprising driving cell balancing with a controller by:
determining, via the controller, that the battery cell groups need to be balanced; and
charging the battery stack to a specified voltage when the battery cell groups need to be balanced.

18. The method of claim 17, wherein the controller determines that the battery cell groups need to be balanced based on a difference in State of Charge (SOC) and/or a difference in Voltage.

19. The method of claim 17, further comprising:
determining, via the controller, that the battery cell groups are in balance; and
ceasing charging of the battery stack to allow the battery cell groups to drain when the battery cell groups are in balance.

20. The method of claim 17, further comprising:
determining, via the controller, that the battery cell groups are in balance; and
ceasing charging of the battery stack and discharging the battery stack to a target charge level when the battery cell groups are in balance.
